(19) United States
(12) Patent Application Publication
(10) Pub. No.: US 2023/0191539 A1
(43) Pub. Date: Jun. 22, 2023

(54) LASER PROCESSING APPARATUS

(71) Applicant: DISCO CORPORATION, Tokyo (JP)

(72) Inventors: Atsushi MAEDA, Tokyo (JP); Tasuku KOYANAGI, Tokyo (JP)

(21) Appl. No.: 18/061,556

(22) Filed: Dec. 5, 2022

(30) Foreign Application Priority Data
Dec. 17, 2021 (JP) 2021-205459

(51) Int. Cl. B23K 26/70

(52) U.S. Cl. CPC B23K 26/707; B23K 2103/56

(57) ABSTRACT

A laser beam irradiation unit of a laser processing apparatus includes a laser oscillator that emits a laser beam, a characteristic conversion optical element that converts a characteristic of the laser beam emitted from the laser oscillator, a mirror and a collecting lens that are optical elements that guide the laser beam to a workpiece, a detecting unit that detects the water retention state of the characteristic conversion optical element, and a drying unit that dries the characteristic conversion optical element.

### BACKGROUND OF THE INVENTION

### Field of the Invention

The present invention relates to a laser processing apparatus.

### Description of the Related Art

Techniques of irradiating a workpiece such as a semiconductor wafer or an optical device wafer with a laser beam to execute processing have been prevalent (for example, refer to Japanese Patent Laid-open No. 2014-143285 and Japanese Patent Laid-open No. 2004-072052).

For the processing of the workpiece, laser beams with various wavelengths such as, commencing with 1064 nm (IR: infrared) that is a fundamental wavelength, 532 nm (green) that is the second harmonic thereof, 355 nm (UV: ultraviolet) that is the third harmonic, and 266 nm (DUV: deep ultraviolet) that is the fourth harmonic are used, and the laser beam is selected according to the use purpose.

Among them, the UV and DUV laser beams of with short wavelengths are attracting attention because of the following features. The laser spot size at the irradiated position can be made small, and therefore, processing with high accuracy can be expected. In addition, these laser beams have high absorptance and high optical energy with respect to various materials, and therefore, application thereof even to materials that are conventionally difficult to process can be expected.

Various optical elements are introduced in a laser processing apparatus for implementing such processing. Examples of the optical element include a laser crystal for oscillating and outputting a laser, a wavelength conversion optical element for converting the wavelength of a laser beam, a wave plate for converting the polarization direction, a mirror for converting the deflection direction of a beam, a lens for focusing collimated light, that is, converting the converging angle of a beam, and so forth.

For example, as the laser crystal, Nd:YAG, ND:YVO4, titanium sapphire, or the like is frequently used. Further, as the wavelength conversion optical element for outputting a DUV laser beam, a cesium lithium borate (CLBO: CsLiB₆O₁₀) crystal has been used in many cases in recent years (for example, refer to Japanese Patent Laid-open No. 2000-292819). Moreover, for the wave plate, the mirror, the lens, and so forth, a transparent material coated with a dielectric multilayer film is frequently used in order to improve reflection characteristics and transmission characteristics thereof.

### SUMMARY OF THE INVENTION

However, it is known that these optical elements deteriorate due to water in air. For example, in the case of the mirror and the wave plate, when water is adsorbed to the dielectric multilayer film, spectral characteristics thereof change and the reflectance and the transmittance change, so that the light amount of the laser beam with which a workpiece is irradiated decreases and the processing quality lowers. Further, the CLBO crystal that is the wavelength conversion optical element exhibits deliquescence. As a result, the CLBO crystal retains water in air and deteriorates, which adversely affects the profile of the laser beam that has passed through the crystal and lowers the processing quality.

Therefore, the above-described optical elements have a problem that replacement and maintenance are frequently required, the downtime of the processing apparatus becomes longer, and therefore, the lowering of the productivity is caused.

Thus, an object of the present invention is to provide a laser processing apparatus capable of implementing processing with high accuracy.

In accordance with an aspect of the present invention, there is provided a laser processing apparatus including a holding table that holds a workpiece, a laser beam irradiation unit that irradiates the workpiece held by the holding table with a laser beam, and a controller. The laser beam irradiation unit includes a laser oscillator having a first optical element that emits the laser beam, a characteristic conversion optical element that converts a characteristic of the laser beam emitted from the laser oscillator, and a second optical element that guides the laser beam for which the characteristic has been converted to the workpiece. The laser beam irradiation unit also includes a detecting unit that detects a water retention state of any of the first optical element of the laser oscillator, the characteristic conversion optical element, and the second optical element and a drying unit that dries any of the first optical element of the laser oscillator, the characteristic conversion optical element, and the second optical element.

Preferably, when the water retention state of any of the first optical element of the laser oscillator, the characteristic conversion optical element, and the second optical element, the water retention state being detected by the detecting unit, exceeds a predetermined value, the controller causes the drying unit to execute drying of any of the first optical element of the laser oscillator, the characteristic conversion optical element, and the second optical element.

Preferably, the laser beam irradiation unit has at least two characteristic conversion optical elements including a first characteristic conversion optical element disposed on an optical path of the laser beam and a second characteristic conversion optical element disposed to be allowed to replace the first characteristic conversion optical element. Further, when determining that drying of the first characteristic conversion optical element is necessary, the controller moves the first characteristic conversion optical element to an outside of the optical path of the laser beam and moves the second characteristic conversion optical element into the optical path of the laser beam, and converts the characteristic of the laser beam by using the second characteristic conversion optical element, to execute processing for the workpiece, while drying the first characteristic conversion optical element by the drying unit.

Preferably, the detecting unit includes a light source that emits light in an infrared region and a detecting part that detects the light that has been emitted from the light source and been transmitted through any of the first optical element of the laser oscillator, the characteristic conversion optical element, and the second optical element. Further, the controller determines the water retention state of any of the first optical element of the laser oscillator, the characteristic conversion optical element, and the second optical element on the basis of transmittance of the light emitted from the light source.

Preferably, the characteristic conversion optical element is a wavelength conversion optical element that converts a wavelength that is the characteristic of the laser beam emitted from the laser oscillator.

Preferably, the wavelength conversion optical element is a CLBO crystal.

The present invention provides an effect that it becomes possible to implement processing with high accuracy.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view illustrating a configuration example of a laser processing apparatus according to a first embodiment;

FIG. 2 is a diagram schematically illustrating a configuration of a laser beam irradiation unit of the laser processing apparatus illustrated in FIG. 1;

FIG. 3 is a diagram schematically illustrating a configuration of a laser beam irradiation unit of a laser processing apparatus according to a second embodiment;

and

FIG. 4 is a diagram illustrating transmittance spectra regarding a wavelength conversion optical element of the laser processing apparatus illustrated in FIG. 1, the transmittance spectra being detected before and after drying of the wavelength conversion optical element.

### DETAILED DESCRIPTION OF THE PREFERRED EMBODIMENTS

Embodiments of the present invention will be described in detail below with reference to the drawings. The present invention is not limited by contents described in the following embodiments. Further, what can easily be envisaged by those skilled in the art and what are substantially the same are included in constituent elements described below. Moreover, configurations described below can be combined as appropriate. In addition, various kinds of omission, replacement, or change of a configuration can be carried out without departing from the gist of the present invention.

### First Embodiment

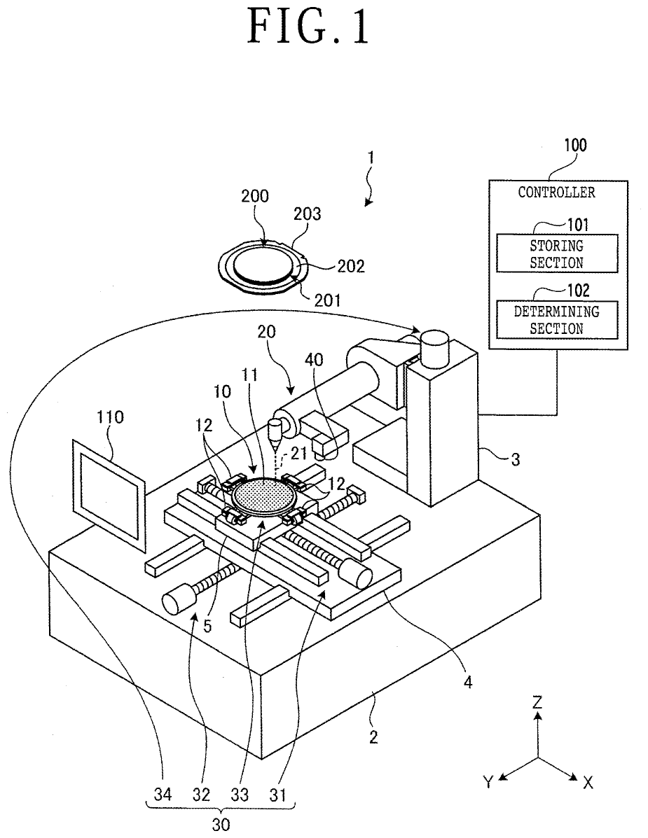

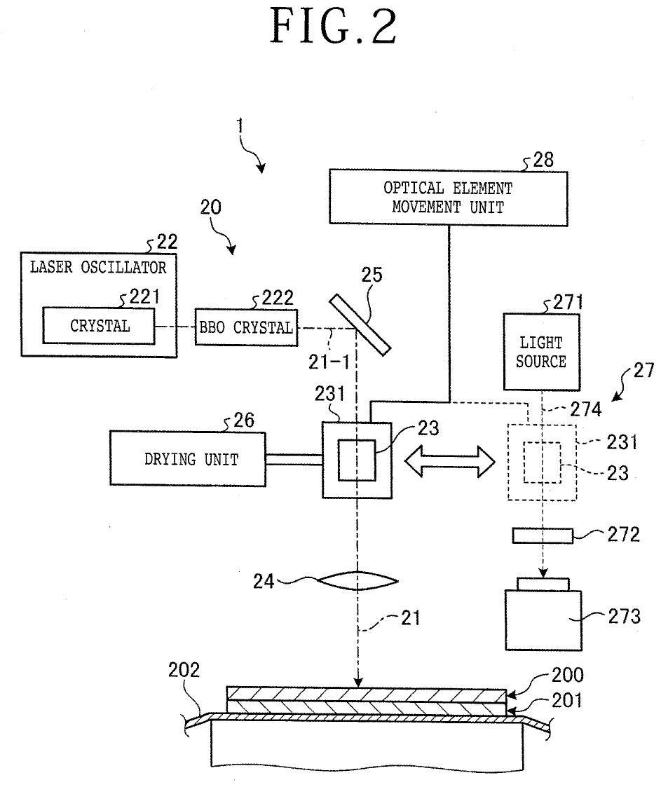

A laser processing apparatus according to a first embodiment of the present invention will be described based on drawings. FIG. 1 is a perspective view illustrating a configuration example of the laser processing apparatus according to the first embodiment. FIG. 2 is a diagram schematically illustrating a configuration of a laser beam irradiation unit of the laser processing apparatus illustrated in FIG. 1.

A laser processing apparatus 1 according to the first embodiment is a processing apparatus that executes laser processing for a workpiece 200. The workpiece 200 that is a processing target of the laser processing apparatus 1 according to the first embodiment is a wafer such as a circular plate-shaped semiconductor wafer including a substrate, a laser beam absorbing layer stacked on a surface of the substrate, and a device layer stacked on the laser beam absorbing layer. In the first embodiment, the substrate is composed of a transparent material such as sapphire and is formed into a circular plate shape. The laser beam absorbing layer is composed of resin, and is composed of polyimide in the first embodiment.

In the device layer, devices are formed in regions marked out by a plurality of planned dividing lines that intersect with each other. For example, the devices are circuits such as integrated circuits (IC) or large scale integration (LSI) circuits, power devices, micro electro mechanical systems (MEMS), or various memories (semiconductor storing devices).

For the above-described workpiece 200, a substrate 201 for relocation composed of glass is stuck, with the interposition of an adhesive layer, to the device layer divided for each device, and executed is what is generally called laser lift-off processing in which the laser beam absorbing layer is broken and the devices are separated from the substrate by irradiation, through the substrate, of the whole surface with a laser beam 21 whose focal point is set in the laser beam absorbing layer and that has a wavelength having transmissibility with respect to the substrate.

Further, in the first embodiment, for the workpiece 200, the substrate 201 for relocation is stuck to the device layer by the adhesive layer, and the side of the substrate 201 for relocation is stuck to a circular plate-shaped tape 202 with a diameter larger than that of the workpiece 200. In addition, an annular frame 203 having an inner diameter larger than the outer diameter of the workpiece 200 is stuck to the outer circumferential edge of the tape 202. Thus, the workpiece 200 is supported in an opening inside the annular frame 203.

The laser processing apparatus 1 illustrated in FIG. 1 is a processing apparatus that sets, in the laser beam absorbing layer, from the back surface side of the substrate of the workpiece 200, the focal point of the pulsed laser beam 21 with a wavelength having transmissibility with respect to the substrate configuring the workpiece 200 and irradiates the whole surface with the laser beam 21 to execute laser lift-off processing and separate the devices from the substrate for the workpiece 200. As illustrated in FIG. 1, the laser processing apparatus 1 has a holding table 10 that holds the workpiece 200, a laser beam irradiation unit 20, a movement unit 30, an imaging unit 40, and a controller 100.

The holding table 10 holds the workpiece 200 by a holding surface 11 that is parallel to the horizontal direction. The holding surface 11 has a circular disc shape formed from a porous ceramic or the like and is connected to an unillustrated vacuum suction source through an unillustrated suction path. By being sucked by the vacuum suction source, the holding table 10 holds under suction the workpiece 200 placed on the holding surface 11. A plurality of clamp parts 12 that clamp the frame 203 supporting the workpiece 200 in the opening are disposed around the holding table 10.

Further, the holding table 10 is rotated around the axial center parallel to a Z-axis direction that is orthogonal to the holding surface 11 and that is parallel to the vertical direction, by a rotational movement unit 33 of the movement unit 30. Together with the rotational movement unit 33, the holding table 10 is moved, by an X-axis movement unit 31 of the movement unit 30, in an X-axis direction (equivalent to a processing traveling direction) parallel to the horizontal direction, and is moved, by a Y-axis movement unit 32, in a Y-axis direction that is parallel to the horizontal direction and that is orthogonal to the X-axis direction. The holding table 10 is moved by the movement unit 30 between a processing region below the laser beam irradiation unit 20 and a carrying-in/out region that is separate from the lower side of the laser beam irradiation unit 20 and to and from which the workpiece 200 is carried in and carried out.

The laser beam irradiation unit 20 is laser beam irradiation means that focuses the pulsed laser beam 21 on the workpiece 200 held by the holding table 10 and that executes irradiation thereof. In the first embodiment, as illustrated in FIG. 1, part of the laser beam irradiation unit 20 is moved in the Z-axis direction by a Z-axis movement unit 34 disposed on an erected wall 3 erected from an apparatus main body 2.

The laser beam irradiation unit 20 is what executes irradiation with the laser beam 21 with a wavelength having transmissibility with respect to the substrate of the workpiece 200 held by the holding table 10 and executes laser processing of the workpiece 200. As illustrated in FIG. 2, the laser beam irradiation unit 20 includes a laser oscillator 22 that emits a pulsed laser beam 21-1, a wavelength conversion optical element 23 (equivalent to the characteristic conversion optical element) that converts the wavelength (equivalent to the characteristic) of the laser beam 21-1 emitted from the laser oscillator 22, and a collecting lens 24 that focuses the laser beam 21 resulting from wavelength conversion executed by the wavelength conversion optical element 23 and that irradiates the workpiece 200 with the laser beam 21. Further, in the first embodiment, the laser beam irradiation unit 20 includes a mirror 25 that reflects the laser beam 21-1 emitted from the laser oscillator 22, toward the wavelength conversion optical element 23.

The laser oscillator 22 includes a crystal 221 that is an optical element configuring a laser medium that oscillates the laser beam 21-1. For example, the crystal 221 includes an yttrium aluminum garnet (YAG: Y₃Al₅O₁₂) crystal, an yttrium orthovanadate (YVO₄) crystal, a titanium sapphire (Ti:Al₂O₃) crystal, or the like. In the first embodiment, the laser oscillator 22 oscillates IR light with a wavelength of 1064 nm. The IR light is converted to green light with a wavelength of 532 nm through a β-BaB₂O₄ (BBO) crystal 222, and this is emitted as the laser beam 21-1. In the present invention, the BBO crystal 222 may be present in the same casing as the laser oscillator 22.

The wavelength conversion optical element 23 is positioned to a conversion position, converts the wavelength of the laser beam 21-1 emitted from the laser oscillator 22, to the laser beam 21 with a shorter wavelength, and emits the converted laser beam 21 toward the collecting lens 24. The conversion position refers to a position at which the wavelength conversion optical element 23 is located on the optical path of the laser beam 21-1 emitted from the laser oscillator 22 and converts the wavelength of the laser beam 21-1 to the laser beam 21 with a shorter wavelength.

In the first embodiment, the wavelength conversion optical element 23 includes a CLBO crystal and is housed in a box-shaped cell 231 whose inside is sealed. The CLBO crystal that configures the wavelength conversion optical element 23 has deliquescence. In the first embodiment, the wavelength conversion optical element 23 converts the laser beam 21-1 of the second harmonic (green) with a wavelength of 532 nm to the laser beam 21 of the fourth harmonic (DW) with a wavelength of 266 nm. The cell 231 includes windows or the like through which the laser beam 21-1 or 21 is transmitted.

The collecting lens 24 is disposed at a position opposed to the holding surface 11 of the holding table 10 in the Z-axis direction. The collecting lens 24 is a focusing optical element that focuses the pulsed laser beam 21 on the workpiece 200 held by the holding table 10 to execute irradiation thereof. The collecting lens 24 allows the laser beam 21 that has been emitted from the laser oscillator 22 and been reflected by the mirror 25 and whose wavelength has been converted by the wavelength conversion optical element 23, to be transmitted through the collecting lens 24, and focuses the laser beam 21 into the focal point (illustrated in FIG. 2 and so forth). In the first embodiment, the collecting lens 24 focuses the focal point of the laser beam 21 on the laser beam absorbing layer of the workpiece 200 held by the holding surface 11 of the holding table 10.

The mirror 25 and the collecting lens 24 are optical elements that guide the laser beams 21-1 and 21 to the workpiece 200. In the embodiment, the laser beam irradiation unit 20 includes the mirror 25 and the collecting lens 24 as optical elements that guide, to the workpiece 200, the laser beams 21-1 and 21 for which wavelength conversion is executed by the wavelength conversion optical element 23. However, in the present invention, for example, the optical elements are not limited to the mirror 25, and the collecting lens 24 and various optical elements that configure a scanning optical system that executes scanning with the laser beams 21-1 and 21, for example, may be included.

Further, as illustrated in FIG. 2, the laser beam irradiation unit 20 includes a drying unit 26, a detecting unit 27, and an optical element movement unit 28. The drying unit 26 is what dries the wavelength conversion optical element 23 in the cell 231. In the first embodiment, the drying unit 26 is what continues to cause dry air from a dry air supply source to flow into the cell 231 while heating the wavelength conversion optical element 23 to 150° C. In the first embodiment, the drying unit 26 includes heating means that heats the wavelength conversion optical element 23 in the cell 231 to 150° C. and a mechanism that continues to cause the dry air from the dry air supply source to flow into the cell 231. The heating means heats the wavelength conversion optical element 23 to 150° C., and the dry air from the dry air supply source is continued to flow into the cell 231, to dry the wavelength conversion optical element 23 in the cell 231. In the present invention, the drying unit 26 may include heating means that heats the inside of the cell 231 to, for example, 150° C. and a pump or the like that degasses the inside of the cell 231. In this case, the drying unit 26 heats the wavelength conversion optical element 23 to 150° C. in the cell 231 by the heating means and degasses the inside of the cell 231 by the pump, to dry the wavelength conversion optical element 23 in the cell 231.

The detecting unit 27 is what detects the water retention state of the wavelength conversion optical element 23. The water retention state refers to the degree of capturing of water (water vapor) in air by the wavelength conversion optical element 23. In the first embodiment, the detecting unit 27 includes a light source 271, a band-pass filter 272, and a detecting part 273.

The light source 271 is what emits light 274 for detection to the wavelength conversion optical element 23 positioned to a detection position separate from the conversion position, that is, the optical path of the laser beam 21-1. The light source 271 irradiates the wavelength conversion optical element 23 positioned to the detection position with the light 274 for detection (light in the infrared region) whose center wavelength is 2800 nm, that is, whose wavenumber is 3600 cm⁻¹. The reason why the light source 271 irradiates the wavelength conversion optical element 23 positioned to the detection position with the light 274 for detection whose center wavelength is 2800 nm, that is, whose wavenumber is 3600 cm⁻¹, is because water molecules readily absorb the light 274 for detection whose center wavelength is 2800 nm, that is, whose wavenumber is 3600 cm⁻¹, and thus it is easy to detect the water retention state of the wavelength conversion optical element 23. As the light source 271, for example, LED2800 W made by Thorlabs, Inc. can be used.

Thus, regarding the light 274 for detection with which the wavelength conversion optical element 23 is irradiated by the light source 271, the amount of light transmitted through the wavelength conversion optical element 23, that is, the transmittance, decreases as the water retention state of the wavelength conversion optical element 23 becomes higher (the amount of water captured by the wavelength conversion optical element 23 becomes larger). Regarding the light 274 for detection with which the wavelength conversion optical element 23 is irradiated by the light source 271, the amount of light transmitted through the wavelength conversion optical element 23, that is, the transmittance, increases as the water retention state of the wavelength conversion optical element 23 becomes lower (the amount of water captured by the wavelength conversion optical element 23 becomes smaller). In the present invention, it suffices for the light 274 for detection emitted by the light source 271 of the detecting unit 27 to involve infrared absorption by water molecules, and the light 274 for detection is not limited to that of the first embodiment.

Incidentally, the wavelength region of the light source 271 is wide and ranges to a wavelength region in which infrared absorption by water molecules is small, in some cases. For example, in the first embodiment, the wavenumber region in which infrared absorption by water molecules is large is limited to 3550 to 3650 cm⁻¹. In contrast, the wavenumber region of the light source 271 ranges from 3400 to 3800 cm⁻¹, and light with such a wavelength as not to be sufficiently absorbed by water molecules is included. As a result, when the water retention state of the wavelength conversion optical element 23 represents a minute change, the transmittance of infrared light often does not sufficiently change. In this case, the detection sensitivity of the water retention state can be improved by inserting, in the optical path, a band-pass filter through which only light in a narrow wavelength region is transmitted.

For example, in the first embodiment, the band-pass filter 272 is disposed between the wavelength conversion optical element 23 and the detecting part 273. In the first embodiment, the band-pass filter 272 allows transmission of light whose wavenumber is in a range of 3500 to 3700 cm⁻¹, and does not allow transmission of light with a wavenumber outside this range. The band-pass filter 272 allows transmission, toward the detecting part 273, of the light 274 for detection whose wavenumber is in a range of 3500 to 3700 cm⁻¹ in the light 274 for detection transmitted through the wavelength conversion optical element 23, and does not allow transmission of the light 274 for detection with a wavenumber outside this range. As a result, the ratio of the light amount of the infrared light absorbed by water molecules to the infrared light with which the wavelength conversion optical element 23 is irradiated increases, and the detection sensitivity of the water retention state improves. Although, in the first embodiment, the detecting unit 27 includes the band-pass filter 272 in order to improve the detection sensitivity of the water retention state, the band-pass filter 272 does not need to be included when improvement in the detection sensitivity is not required or when the wavelength region of the light source is sufficiently narrow.

The detecting part 273 is what receives the light 274 for detection that has been emitted from the light source 271 and been sequentially transmitted through the wavelength conversion optical element 23 positioned to the detection position and the band-pass filter 272, detects the light amount of the received light 274 for detection, and outputs information indicating the light amount of the received light 274 for detection to the controller 100. In the first embodiment, the detecting part 273 is a photodiode that receives infrared whose wavelength is 1 to 10.6 μm and outputs information indicating the light amount of the received infrared to the controller 100. As the detecting part 273, for example, VML8T4 made by Thorlabs, Inc. can be used.

By receiving, by the detecting part 273, the light 274 for detection that has been emitted from the light source 271 and been transmitted through the wavelength conversion optical element 23 positioned to the detection position and outputting the information indicating the amount of received light to the controller 100, the detecting unit 27 detects the state quantity that changes according to the water retention state of the wavelength conversion optical element 23 and outputs the detected result to the controller 100.

The optical element movement unit 28 is what moves the wavelength conversion optical element 23 between the conversion position and the detection position. The conversion position is the position of the wavelength conversion optical element 23 which position is located on the optical path of the laser beam 21-1 and at which the wavelength conversion optical element 23 in the cell 231 is irradiated with the laser beam 21-1 and the wavelength conversion optical element 23 executes wavelength conversion and emits the laser beam 21 resulting from the wavelength conversion toward the collecting lens 24. Further, the conversion position is also the position of the wavelength conversion optical element 23 at which the wavelength conversion optical element 23 is not irradiated with the light 274 for detection from the light source 271.

The detection position is the position of the wavelength conversion optical element 23 which position is separate from the optical path of the laser beam 21-1 and at which the wavelength conversion optical element 23 in the cell 231 is not irradiated with the laser beam 21-1. Moreover, the detection position is also the position of the wavelength conversion optical element 23 at which the wavelength conversion optical element 23 is irradiated with the light 274 for detection from the light source 271 and allows transmission of the light 274 for detection toward the band-pass filter 272 and the detecting part 273.

In the first embodiment, the optical element movement unit 28 moves the cell 231 that houses the wavelength conversion optical element 23, to move the wavelength conversion optical element 23 between the conversion position and the detection position.

The laser beam irradiation unit 20 executes laser lift-off processing in which the laser beam irradiation unit 20 irradiates the workpiece 200 held by the holding table 10 with the laser beam 21 with a wavelength with which the substrate of the workpiece 200 has transmissibility, to break the laser beam absorbing layer of the workpiece 200 and separate the devices from the substrate.

The movement unit 30 illustrated in FIG. 1 is what relatively moves the holding table 10 and the focal point of the laser beam 21 with which irradiation is executed by the laser beam irradiation unit 20, in the X-axis direction, the Y-axis direction, and the Z-axis direction and around the axial center parallel to the Z-axis direction. The X-axis direction and the Y-axis direction are directions that are orthogonal to each other and are parallel to the holding surface 11 (that is, horizontal direction). The Z-axis direction is the direction orthogonal to the X-axis direction and the Y-axis direction, that is, the holding surface 11. The movement unit 30 includes the X-axis movement unit 31 that is a processing feed unit that moves the holding table 10 in the X-axis direction, the Y-axis movement unit 32 that is an indexing feed unit that moves the holding table 10 in the Y-axis direction, the rotational movement unit 33 that rotates the holding table 10 around the axial center parallel to the Z-axis direction, and the Z-axis movement unit 34 that moves part of the laser beam irradiation unit 20 in the Z-axis direction.

The Y-axis movement unit 32 is a unit that executes indexing feed of the holding table 10 and the focal point of the laser beam 21 of the laser beam irradiation unit 20 relatively. In the first embodiment, the Y-axis movement unit 32 is installed on the apparatus main body 2 of the laser processing apparatus 1. The Y-axis movement unit 32 supports, movably in the Y-axis direction, a moving plate 4 that supports the X-axis movement unit 31.

The X-axis movement unit 31 is feed means that executes processing feed of the holding table 10 and the focal point of the laser beam 21 of the laser beam irradiation unit 20 relatively. The X-axis movement unit 31 is installed on the moving plate 4. The X-axis movement unit 31 supports, movably in the X-axis direction, a second moving plate 5 that supports the rotational movement unit 33 that rotates the holding table 10 around the axial center parallel to the Z-axis direction. The second moving plate 5 supports the rotational movement unit 33 and the holding table 10. The rotational movement unit 33 supports the holding table 10.

The X-axis movement unit 31, the Y-axis movement unit 32, and the Z-axis movement unit 34 include well-known ball screws disposed rotatably around the axial center, well-known pulse motors that rotate the ball screws around the axial center, and well-known guide rails that support, movably in the X-axis direction, the Y-axis direction, or the Z-axis direction, the moving plates 4 and 5 and the collecting lens 24 included in the laser beam irradiation unit 20. The rotational movement unit 33 includes a motor or the like that rotates the holding table 10 around the axial center.

Further, the laser processing apparatus 1 includes an X-axis direction position detecting unit that is for detecting the position of the holding table 10 in the X-axis direction and is not illustrated, a Y-axis direction position detecting unit that is for detecting the position of the holding table 10 in the Y-axis direction and is not illustrated, and a Z-axis direction position detecting unit that is for detecting the position of the laser beam irradiation unit 20 in the Z-axis direction and is not illustrated. Each position detecting unit outputs the detection result to the controller 100.

The imaging unit 40 is what images the workpiece 200 held by the holding table 10. The imaging unit 40 includes an imaging element such as a charge coupled device (CCD) imaging element or a complementary metal oxide semiconductor (CMOS) imaging element in which an objective lens images an object opposed in the Z-axis direction. In the first embodiment, the imaging unit 40 is attached to the laser beam irradiation unit 20, and the objective lens is disposed at a position that lines up with the collecting lens 24 along the X-axis direction.

The imaging unit 40 acquires an image obtained by imaging by the imaging element and outputs the acquired image to the controller 100. Further, the imaging unit 40 images the workpiece 200 held by the holding surface 11 of the holding table 10 and acquires an image for performing alignment to execute position adjustment between the workpiece 200 and the laser beam irradiation unit 20.

The controller 100 is what controls each of the above-described constituent elements of the laser processing apparatus 1 and causes the laser processing apparatus 1 to execute laser processing operation for the workpiece 200. The controller 100 is a computer having a calculation processing device having a microprocessor such as a central processing unit (CPU), a storing device having a memory such as a read only memory (ROM) or a random access memory (RAM), and an input-output interface device. The calculation processing device of the controller 100 executes calculation processing according to a computer program stored in the storing device and outputs a control signal for controlling the laser processing apparatus 1 to the above-described constituent elements of the laser processing apparatus 1 through the input-output interface device to implement functions of the controller 100.

Moreover, the laser processing apparatus 1 includes a display unit 110 that is display means including a liquid crystal display device or the like that displays the state of processing operation, images, and so forth, an input unit that is input means used when an operator inputs a processing condition or the like, and so forth. The display unit 110 and the input unit are connected to the controller 100. The input unit includes at least one of a touch panel disposed in the display unit 110 and an external input device such as a keyboard.

Further, as illustrated in FIG. 1, the controller 100 includes a storing section 101 and a determining section 102. The storing section 101 stores the light amount obtained when the detecting part 273 receives the light 274 for detection that has been emitted by the light source 271 and been transmitted through the band-pass filter 272 without irradiation of the wavelength conversion optical element 23 with the light 274 for detection. In the first embodiment, the storing section 101 stores the light amount obtained when the detecting part 273 receives the light 274 for detection that has been emitted by the light source 271 and been transmitted through the band-pass filter 272 when the wavelength conversion optical element 23 is positioned to the conversion position.

The determining section 102 is what determines the water retention state of the wavelength conversion optical element 23 on the basis of the transmittance of the light 274 for detection emitted from the light source 271. The determining section 102 computes the transmittance of the light 274 for detection regarding the wavelength conversion optical element 23 on the basis of the light amount stored in the storing section 101 and the light amount obtained when the detecting part 273 receives the light 274 for detection that has been emitted by the light source 271 and been transmitted through the wavelength conversion optical element 23 positioned to the detection position and the band-pass filter 272.

In the first embodiment, the determining section 102 computes the transmittance (equivalent to the water retention state) of the light 274 for detection regarding the wavelength conversion optical element 23 in such a manner as to regard the light amount which is obtained when the detecting part 273 receives the light 274 for detection that has been emitted by the light source 271 and been transmitted through the band-pass filter 272 without irradiation of the wavelength conversion optical element 23 with the light 274 for detection and which is stored in the storing section 101 as 100% and regard the light amount obtained when the detecting part 273 does not receive the light 274 for detection as 0%. The determining section 102 determines the water retention state of the wavelength conversion optical element 23 by determining whether or not the computed transmittance of the light 274 for detection is equal to or higher than a predetermined value defined in advance. In the first embodiment, the predetermined value is set to 13%, for example. However, the predetermined value may be set to a value other than this in view of the wavelength regions of the band-pass filter 272 and the light source 271, for example.

When determining that the computed transmittance of the light 274 for detection is equal to or higher than the predetermined value defined in advance, the determining section 102 determines that the wavelength conversion optical element 23 is suitable for processing of the workpiece 200, and does not operate the drying unit 26. When determining that the computed transmittance of the light 274 for detection is lower than the predetermined value defined in advance, the determining section 102 determines that the water retention state of the wavelength conversion optical element 23 exceeds a predetermined value that is a certain water retention amount and that the wavelength conversion optical element 23 is not suitable for processing of the workpiece 200, and operates the drying unit 26 to dry the wavelength conversion optical element 23.

Functions of the storing section 101 are implemented by the above-described storing device. Further, functions of the determining section 102 are implemented through execution of calculation processing by the calculation processing device according to a computer program stored in the storing device.

Next, processing operation of the laser processing apparatus 1 with the above-described configuration will be described. In the laser processing apparatus 1, the controller 100 accepts and registers a processing condition input by an operator, and the substrate 201 for relocation stuck to the device layer of the workpiece 200 is placed on the holding surface 11 of the holding table 10 positioned to the carrying-in/out region. The laser processing apparatus 1 starts the processing operation when the controller 100 accepts an instruction to start the processing operation from the operator.

In the processing operation, in the laser processing apparatus 1, the controller 100 causes the holding surface 11 of the holding table 10 to hold the workpiece 200 under suction and causes the clamp parts 12 to clamp the frame 203. In the processing operation, in the laser processing apparatus 1, the controller 100 positions the wavelength conversion optical element 23 to the conversion position. In the processing operation, in the laser processing apparatus 1, the controller 100 controls the movement unit 30 to move the holding table 10 to the processing region, and images the workpiece 200 held under suction by the holding table 10 by the imaging unit 40, to acquire an image and perform alignment.

In the processing operation, the laser processing apparatus 1 sets the focal point of the laser beam irradiation unit 20 in the laser beam absorbing layer, and executes irradiation with the pulsed laser beam 21 from the back surface side of the substrate of the workpiece 200 while relatively moving the holding table 10 and the focal point of the laser beam irradiation unit 20.

In the first embodiment, in the processing operation, the laser processing apparatus 1 irradiates the laser beam absorbing layer with the laser beam 21 across the whole surface of the workpiece 200 and breaks the laser beam absorbing layer across the whole surface of the workpiece 200.

In the processing operation, when having broken the laser beam absorbing layer across the whole surface of the workpiece 200, the laser processing apparatus 1 stops the irradiation with the laser beam 21 and moves the holding table 10 to the carrying-in/out region. In the processing operation, the laser processing apparatus 1 positions the holding table 10 to the carrying-in/out region, stops holding the workpiece 200 under suction by the holding table 10, and releases the clamping of the frame 203 by the clamp parts 12 to end the processing operation.

Further, in the laser processing apparatus 1, the controller 100 periodically positions the wavelength conversion optical element 23 to the detection position, irradiates the wavelength conversion optical element 23 with the light 274 for detection emitted from the light source 271, and receives, by the detecting part 273, the light 274 for detection transmitted through the wavelength conversion optical element 23 and the band-pass filter 272. In the laser processing apparatus 1, the determining section 102 of the controller 100 computes the transmittance of the light 274 for detection regarding the wavelength conversion optical element 23 on the basis of the light amount stored in the storing section 101 and the light amount obtained when the detecting part 273 receives the light 274 for detection that has been emitted by the light source 271 and been transmitted through the wavelength conversion optical element 23 positioned to the detection position and the band-pass filter 272.

The determining section 102 of the controller 100 determines whether or not the computed transmittance of the light 274 for detection is equal to or higher than the predetermined value defined in advance. When determining that the computed transmittance of the light 274 for detection is equal to or higher than the predetermined value defined in advance, the determining section 102 determines that the wavelength conversion optical element 23 is suitable for processing of the workpiece 200, and positions the wavelength conversion optical element 23 to the conversion position without operating the drying unit 26, to execute the processing operation. When determining that the computed transmittance of the light 274 for detection is lower than the predetermined value defined in advance, that is, the water retention state exceeds the predetermined amount, the determining section 102 of the controller 100 determines that the wavelength conversion optical element 23 is not suitable for processing of the workpiece 200, operates the drying unit 26 while keeping the wavelength conversion optical element 23 positioned to the detection position, and dries the wavelength conversion optical element 23.

When determining that the computed transmittance of the light 274 for detection is lower than the predetermined value defined in advance and operating the drying unit 26, the determining section 102 of the controller 100 executes the following operation every predetermined period (for example, two weeks). The determining section 102 stops the drying unit 26 and executes irradiation with the light 274 for detection emitted from the light source 271. Further, the determining section 102 computes the transmittance of the light 274 for detection regarding the wavelength conversion optical element 23 and determines whether or not the computed transmittance of the light 274 for detection is equal to or higher than the predetermined value defined in advance. In this manner, in the first embodiment, the determining section 102 of the controller 100 causes the drying unit 26 to execute drying of the wavelength conversion optical element 23 when the water retention state of the wavelength conversion optical element 23 detected by the detecting unit 27 exceeds the predetermined value. Moreover, the laser processing apparatus 1 operates the drying unit 26 and suspends the processing operation until the transmittance of the light 274 for detection regarding the wavelength conversion optical element 23 becomes equal to or higher than the predetermined value defined in advance.

In the first embodiment, the drying unit 26 is operated and the processing operation is suspended until the transmittance of the light 274 for detection regarding the wavelength conversion optical element 23 becomes equal to or higher than the predetermined value defined in advance. However, in the present invention, when it is determined that the transmittance of the light 274 for detection is lower than the predetermined value defined in advance, the workpiece 200 may be irradiated with the laser beam 21 to process the workpiece 200 while the drying unit 26 is operated and the wavelength conversion optical element 23 is dried with the wavelength conversion optical element 23 kept positioned to the conversion position. In the present invention, the predetermined period can freely be set. For example, in the present invention, when it can be confirmed that the water retention state has improved to a certain extent, the predetermined period can freely be set by computing how long a period is needed until the transmittance becomes equal to or higher than the predetermined value defined in advance. The predetermined period may be set by an operator or may be set by being automatically computed by the controller 100 or the like.

The laser processing apparatus 1 according to the first embodiment described above includes the detecting unit 27 that detects the water retention state of the wavelength conversion optical element 23 and therefore can previously prevent an adverse effect on the processing quality due to the deliquescence because the laser processing apparatus 1 includes the drying unit 26 that dries the wavelength conversion optical element 23 when the water retention state detected by the detecting unit 27 exceeds the certain water retention amount. As a result, the laser processing apparatus 1 provides an effect that it becomes possible to implement processing with high accuracy.

Further, in the laser processing apparatus 1 according to the first embodiment, the band-pass filter 272 is disposed in front of the detecting part 273 of the detecting unit 27, and therefore, the detection sensitivity of the detecting part 273 can be improved.

### Second Embodiment

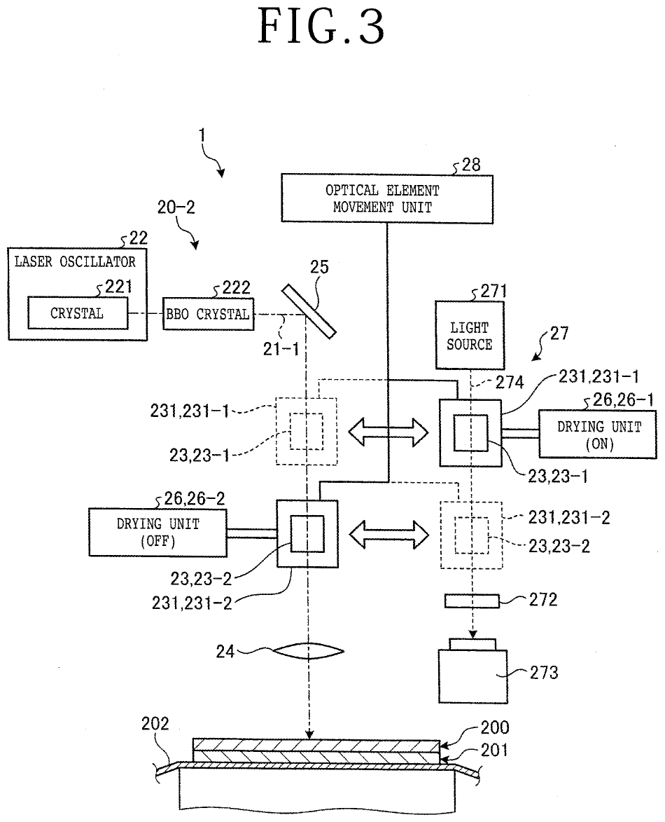

A laser processing apparatus according to a second embodiment of the present invention will be described based on a drawing. FIG. 3 is a diagram schematically illustrating a configuration of a laser beam irradiation unit of the laser processing apparatus according to the second embodiment. In FIG. 3, the same part as the first embodiment is given the same numeral, and description thereof is omitted.

A laser beam irradiation unit 20-2 of the laser processing apparatus 1 according to the second embodiment includes a first wavelength conversion optical element 23-1 and a second wavelength conversion optical element 23-2 as the wavelength conversion optical elements 23 and a first drying unit 26-1 and a second drying unit 26-2 as the drying units 26 as illustrated in FIG. 3. The wavelength conversion optical elements 23-1 and 23-2 have the same configuration as that of the wavelength conversion optical element 23 of the first embodiment and are each housed in the cell 231. The cells 231 also have the same configuration as that of the cell 231 that houses the wavelength conversion optical element 23 of the first embodiment and are moved between the conversion position and the detection position by the optical element movement unit 28 in the state in which they house the wavelength conversion optical elements 23-1 and 23-2, similarly to the first embodiment.

As above, in the second embodiment, the laser beam irradiation unit 20-2 has at least two wavelength conversion optical elements 23-1 and 23-2 including the first wavelength conversion optical element 23-1 disposed in the optical path of the laser beam 21-1 and the second wavelength conversion optical element 23-2 disposed in the optical path of the laser beam 21-1 in such a manner as to be allowed to replace the first wavelength conversion optical element 23-1.

The drying units 26-1 and 26-2 have the same configuration as that of the drying unit 26 of the first embodiment, correspond to the wavelength conversion optical elements 23-1 and 23-2 in a one-to-one relation, and dry the corresponding one of the wavelength conversion optical elements 23-1 and 23-2. In the present invention, one drying unit may be connected to both the wavelength conversion optical elements 23-1 and 23-2.

In the laser processing apparatus 1, in the processing operation, the controller 100 positions one of the wavelength conversion optical elements 23-1 and 23-2 to the conversion position and positions the other to the detection position, to execute the processing operation. In the laser processing apparatus 1, the controller 100 periodically positions either one of the wavelength conversion optical elements 23-1 and 23-2 to the detection position, irradiates the wavelength conversion optical element 23 with the light 274 for detection emitted from the light source 271, and receives, by the detecting part 273, the light 274 for detection transmitted through the wavelength conversion optical element 23 and the band-pass filter 272.

In the laser processing apparatus 1, the determining section 102 of the controller 100 computes the transmittance of the light 274 for detection regarding one of the wavelength conversion optical elements 23-1 and 23-2 on the basis of the light amount stored in the storing section 101 and the light amount obtained when the detecting part 273 receives the light 274 for detection that has been emitted by the light source 271 and been transmitted through the one of the wavelength conversion optical elements 23-1 and 23-2 positioned to the detection position and the band-pass filter 272.

In a state in which the one of the wavelength conversion optical elements 23-1 and 23-2 regarding which it is determined that the computed transmittance of the light 274 for detection is lower than the predetermined value defined in advance is kept positioned to the detection position, the determining section 102 of the controller 100 operates the drying unit 26 to dry the one of the wavelength conversion optical elements 23-1 and 23-2. In addition, the determining section 102 positions the other to the conversion position and executes the processing operation.

In this manner, in the second embodiment, when determining that drying of the first wavelength conversion optical element 23-1 is necessary, the determining section 102 of the controller 100 executes wavelength conversion of the laser beam 21-1 by using the second wavelength conversion optical element 23-2, to execute processing for the workpiece 200, while drying the first wavelength conversion optical element 23-1 by the first drying unit 26-1.

Similarly to the first embodiment, the laser processing apparatus 1 according to the second embodiment includes the detecting unit 27 that detects the water retention state of the wavelength conversion optical element 23 and therefore can previously prevent an adverse effect on the processing quality due to the deliquescence because the laser processing apparatus 1 according to the second embodiment includes the drying units 26-1 and 26-2 that dry the wavelength conversion optical element 23-1 or 23-2 when the water retention state detected by the detecting unit 27 exceeds the certain water retention amount. As a result, the laser processing apparatus 1 provides an effect that it becomes possible to implement processing with high accuracy.

Further, in drying of one of the wavelength conversion optical elements 23-1 and 23-2, the laser processing apparatus 1 according to the second embodiment positions the other to the conversion position and executes the processing operation. Therefore, it becomes possible to eliminate the downtime, which contributes to improvement in the productivity.

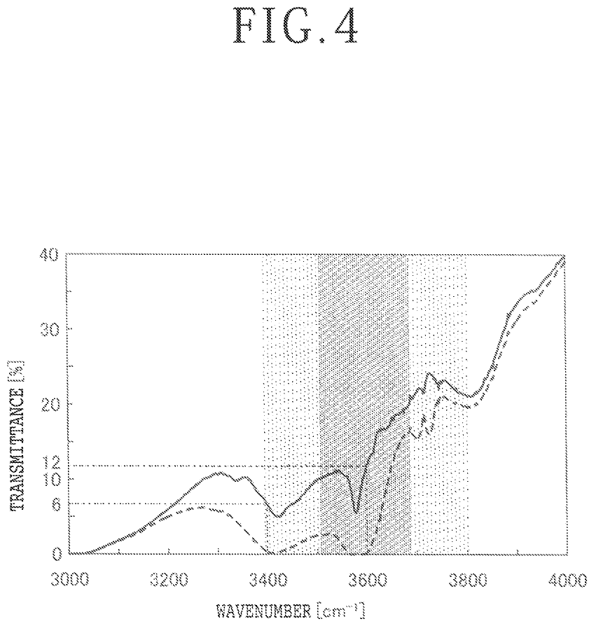

Next, the inventors of the present invention checked effects of the laser processing apparatus 1 of the first embodiment. The result is illustrated in FIG. 4 and the following Table 1. FIG. 4 is a diagram illustrating transmittance spectra regarding the wavelength conversion optical element of the laser processing apparatus illustrated in FIG. 1, the transmittance spectra being detected before and after drying of the wavelength conversion optical element.

TABLE 1

| | Transmittance [%] | |
|---|---|---|
| | Before drying | After drying |
| Without band-pass filter | 9 | 12 |
| With band-pass filter | 5 | 15 |

In the check, the transmittance spectra before and after drying regarding the wavelength conversion optical element 23 were measured by a Fourier transform infrared spectroscopy. Thereafter, with regard to the transmittances before and after drying regarding the wavelength conversion optical element 23, which would be detected by use of the light 274 for detection whose center wavenumber was 3600 cm⁻¹, simulation was performed for a case in which the band-pass filter 272 was present and a case in which it was absent.

The abscissa axis of FIG. 4 indicates the wavenumber of the light, and the ordinate axis of FIG. 4 indicates the transmittance of the wavelength conversion optical element 23. FIG. 4 illustrates the transmittance regarding the wavelength conversion optical element 23, the transmittance being detected before drying, by a dashed line and illustrates the transmittance detected after drying by a solid line. Further, regions filled with coarse dots indicate the wavenumber region of the light source, and a region filled with fine dots indicates the wavenumber region of light transmitted through the band-pass filter 272.

Moreover, Table 1 indicates the transmittances regarding the wavelength conversion optical element 23, which were detected before and after drying and would be detected by use of the light 274 for detection whose center wavenumber was 3600 cm⁻¹, with regard to a case in which the band-pass filter 272 was present and a case in which it was absent.

According to FIG. 4, the transmittances of the light 274 for detection whose wavenumber was 3400 cm⁻¹ and 3600 cm⁻¹ before drying were almost zero. In contrast, the transmittance of the light 274 for detection whose wavenumber was 3400 cm⁻¹ after drying was approximately 6%, and the transmittance of the light 274 for detection whose wavenumber was 3600 cm⁻¹ was approximately 12%.

From these spectra, as indicated in a field of “With band-pass filter” in Table 1, a simulation result that the transmittance detected in the first embodiment was 5% before drying and was 15% after drying was obtained. That is, an estimation that the transmittance increases by a factor of three due to the drying was obtained. From these results, it proves that the detecting unit 27 can detect the water retention state of the wavelength conversion optical element 23.

On the other hand, as indicated in Table 1, in the case in which the band-pass filter 272 was absent, a simulation result that the transmittances of the light 274 for detection before and after drying were 9% and 12%, respectively, was obtained. That is, this is an estimation that the magnification of increase in the transmittance due to the drying remains at 1.3. From this result, it proves that the detecting unit 27 can improve the sensitivity of the detecting part 273 when the detecting unit 27 includes the band-pass filter 272.

The present invention is not limited to the above-described embodiments. That is, the present invention can be carried out with various modifications without departing from the gist of the present invention. In the above-described embodiments, the water retention state of the wavelength conversion optical element 23, 23-1, or 23-2 is detected, and the drying unit 26, 26-1, or 26-2 executes drying when the water retention state exceeds the certain water retention amount. However, in the present invention, the water retention state of the crystal of the laser oscillator 22 and various optical elements may be detected, and the drying unit 26, 26-1, or 26-2 may execute drying when the water retention state exceeds the certain water retention amount. That is, in the present invention, the detecting unit 27 may detect the water retention state of any of the crystal 221 of the laser oscillator 22, the wavelength conversion optical elements 23, 23-1, and 23-2, and the optical elements, and the drying unit 26, 26-1, or 26-2 may dry any of the crystal 221 of the laser oscillator 22, the wavelength conversion optical elements 23, 23-1, and 23-2, and the optical elements.

That is, in the present invention, when the water retention state of any of the crystal 221 of the laser oscillator 22, the wavelength conversion optical elements 23, 23-1, and 23-2, and the optical elements, the water retention state being detected by the detecting unit 27, exceeds the predetermined value, the determining section 102 of the controller 100 may cause the drying unit 26, 26-1, or 26-2 to execute drying of any of the crystal 221 of the laser oscillator 22, the wavelength conversion optical elements 23, 23-1, and 23-2, and the optical elements. Further, in the present invention, the detecting part 273 of the detecting unit 27 may detect the light 274 for detection transmitted through any of the crystal 221 of the laser oscillator 22, the wavelength conversion optical elements 23, 23-1, and 23-2, and the optical elements, and the determining section 102 of the controller 100 may determine the water retention state of any of the crystal 221 of the laser oscillator 22, the wavelength conversion optical elements 23, 23-1, and 23-2, and the optical elements on the basis of the transmittance of the light 274 for detection emitted from the light source 271.

Moreover, in the above-described embodiments, the laser processing apparatus 1 executes laser lift-off processing for the workpiece 200. However, in the present invention, laser processing by which the workpiece 200 is fully cut along planned dividing lines or laser processing by which processing grooves are formed in the workpiece 200 along planned dividing lines may be executed.

Further, in the present invention, the optical elements may be optical elements for which coating of a dielectric multilayer film or the like whose characteristic changes when retaining water is executed, such as a lens, a mirror, and a wave plate. Moreover, in the present invention, the optical element may be a laser crystal of Nd:YAG, ND:YVO4, titanium sapphire, or the like. Further, in the present invention, the optical element may be the BBO crystal 222. In the present invention, the optical elements are what are included in the optical system of the laser processing apparatus 1 and are also what are included inside the laser oscillator 22.

Moreover, in the above-described embodiments, described are the examples in which the characteristic conversion optical elements are the wavelength conversion optical elements 23, 23-1, and 23-2 that convert the wavelength that is a characteristic of the laser beam 21-1 emitted from the laser oscillator 22. However, in the present invention, the characteristic conversion optical element may be an optical element that converts a characteristic other than the wavelength regarding the laser beam 21-1 or the like. That is, the present invention may be applied also to a processing apparatus that does not include the wavelength conversion optical elements 23, 23-1, and 23-2.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing apparatus comprising:
a holding table that holds a workpiece;
a laser beam irradiation unit that irradiates the workpiece held by the holding table with a laser beam; and
a controller,
wherein the laser beam irradiation unit includes
a laser oscillator having a first optical element that emits the laser beam,
a characteristic conversion optical element that converts a characteristic of the laser beam emitted from the laser oscillator,
a second optical element that guides the laser beam for which the characteristic has been converted to the workpiece,
a detecting unit that detects a water retention state of any of the first optical element of the laser oscillator, the characteristic conversion optical element, and the second optical element, and
a drying unit that dries any of the first optical element of the laser oscillator, the characteristic conversion optical element, and the second optical element.

2. The laser processing apparatus according to claim 1, wherein,
when the water retention state of any of the first optical element of the laser oscillator, the characteristic conversion optical element, and the second optical element, the water retention state being detected by the detecting unit, exceeds a predetermined value, the controller causes the drying unit to execute drying of any of the first optical element of the laser oscillator, the characteristic conversion optical element, and the second optical element.

3. The laser processing apparatus according to claim 1, wherein
the laser beam irradiation unit has at least two characteristic conversion optical elements including a first characteristic conversion optical element disposed on an optical path of the laser beam and a second characteristic conversion optical element disposed to be allowed to replace the first characteristic conversion optical element, and,
when determining that drying of the first characteristic conversion optical element is necessary, the controller moves the first characteristic conversion optical element to an outside of the optical path of the laser beam and moves the second characteristic conversion optical element into the optical path of the laser beam, and converts the characteristic of the laser beam by using the second characteristic conversion optical element, to execute processing for the workpiece, while drying the first characteristic conversion optical element by the drying unit.

4. The laser processing apparatus according to claim 1, wherein
the detecting unit includes
a light source that emits light in an infrared region, and
a detecting part that detects the light that has been emitted from the light source and been transmitted through any of the first optical element of the laser oscillator, the characteristic conversion optical element, and the second optical element, and
the controller determines the water retention state of any of the first optical element of the laser oscillator, the characteristic conversion optical element, and the second optical element on a basis of transmittance of the light emitted from the light source.

5. The laser processing apparatus according to claim 1, wherein
the characteristic conversion optical element is a wavelength conversion optical element that converts a wavelength that is the characteristic of the laser beam emitted from the laser oscillator.

6. The laser processing apparatus according to claim 5, wherein
the wavelength conversion optical element is a cesium lithium borate crystal.
